(19) United States
(12) Patent Application Publication
(10) Pub. No.: US 2005/0190513 A1
(43) Pub. Date: Sep. 1, 2005

(54) Surge suppression circuit

(75) Inventor: John Gaughan, Gilberts, IL (US)

Correspondence Address: FOLEY AND LARDNER;SUITE 500, 3000 K STREET NW, WASHINGTON, DC, 20007, US

(73) Assignee: OMRON CORPORATION

(21) Appl. No.: 10/788,421

(22) Filed: Mar. 1, 2004

(51) Int. Cl. H02H 9/00

(52) U.S. Cl. 361/56

(57) ABSTRACT

A surge suppression circuit is formed of first and second transistors which are arranged as a complementary Darlington pair.

### BACKGROUND OF THE INVENTION

1. Field of the Invention

The present invention relates to a surge suppressing circuit and more specifically to a surge suppressing circuit which has a high gain, exhibits a high withstand voltage and low voltage drop and which can be fabricated from off the shelf components and is therefore cost effective

2. Description of the Related Art

Transient surge protection circuits of various designs which use single transistors have been proposed. These single transistor solutions typically require an expensive and unique transistor. Further, some configurations will actually turn off completely during a transient voltage event and cause an interrupt in the power supply. Therefore, there exists a need for a simple, inexpensive surge suppression circuit arrangement which can be used in electrical components such as those used in vehicles including aircraft, boats/ships and automotive vehicles and which will address the above-mentioned shortcomings.

### SUMMARY OF THE INVENTION

The present invention resides in the application of a complementary Darlington transistor pair which is used as a voltage follower and surge protection circuit. In a nutshell, a PNP and a NPN transistor are arranged to function as a single NPN transistor with the advantage of high gain, low voltage drop and a wide operating current.

The embodiment of the present invention finds advantageous application in providing protection from voltage transients which occur in automotive electrical systems and can be used to regulate the positive supply feed in order to protect other components within an electronic module. The invention is, of course, not so limited and can be used in any suitable situation wherein surge protection is required.

Since the embodiment of the invention can be fabricated from commercially available components, the individual components can be readily purchased from a number of different suppliers.

More specifically, a first aspect of the invention resides in surge suppression circuit comprising first and second transistors which are arranged as a complementary Darlington pair.

The above-mentioned Darlington pair is arranged with a resistor, which is connected between the emitter of the first transistor and the base of the second transistor; and a Zener diode which is connected between the base of the second transistor and ground. The first transistor is a PNP type transistor and the second transistor is a NPN type transistor. In this arrangement, the collector of the second transistor is connected to the base of the first transistor.

A diode is circuited with the emitter of the first transistor and the resistor is connected to a junction between the diode and the emitter of the first transistor. A capacitor can be connected between ground and the base of the second transistor.

A second aspect of the invention resides in a method of surge suppression comprising interposing a complementary Darlington pair between an input and output. In this method the complementary Darlington pair is configured by using a PNP transistor as the first transistor; using a NPN transistor as the second transistor; and connecting the base of the first transistor to the collector of the second transistor. In addition to this, the method additionally comprises arranging a resistor between the input and a base of the second transistor; and connecting the base of the second transistor to ground via a Zener diode.

### BRIEF DESCRIPTION OF THE DRAWINGS

The various features and advantages of the present invention will become more clearly understood as a detailed description of the exemplary embodiments is given with reference to the appended drawings wherein:

FIG. 1 is a schematic circuit diagram showing a circuit arrangement according to an embodiment of the invention; and

FIG. 2 is a schematic circuit diagram showing the embodiment of the surge suppressing circuit arrangement according to invention incorporated into a circuit such as that found on a circuit board of an automotive component.

### DESCRIPTION OF THE EXEMPLARY EMBODIMENTS

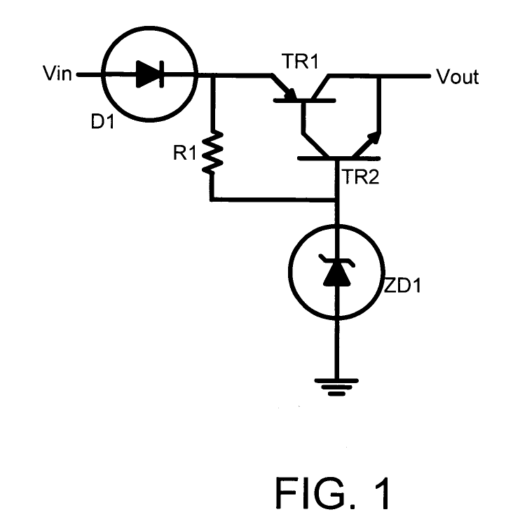

FIG. 1 shows an embodiment of the invention. In this arrangement diode D1, a resistor R1, transistors TR1 and TR2 and a Zener diode ZD1, are circuited in the illustrated manner. The arrangement of the transistors TR1 and TR2 which are respectively PNP and NPN types, of course comprises a Darlington pair. As noted above, this arrangement of transistors is such as to act as a single NPN transistor.

This circuit exhibits high gain and therefore requires a very small base current through TR2 in order to operate. The small base current allows for minimal voltage drop across R1 and the base emitter junction of TR2. The invention also allows for a wide range of operating current without exhibiting any substantial voltage drop. The maximum operation current is still limited by the power dissipation properties of the transistors and the maximum operating temperature that the components must endure.

The clamping voltage of this arrangement can be customized to the operating limits of an electronic module by changing the Zener diode voltage of Zener diode ZD1.

In the case of a current surge, the normally low current passing through TR2 rises. The voltage across R1 increases and the Zener diode voltage is reached. The Zener diode ZD1 thus becomes conductive and excess current is directed to ground. Upon the current passing through R1 reducing to normal the attendant voltage reduction applied to the Zener diode ZD1 lowers to a level whereat it is rendered non-conductive again.

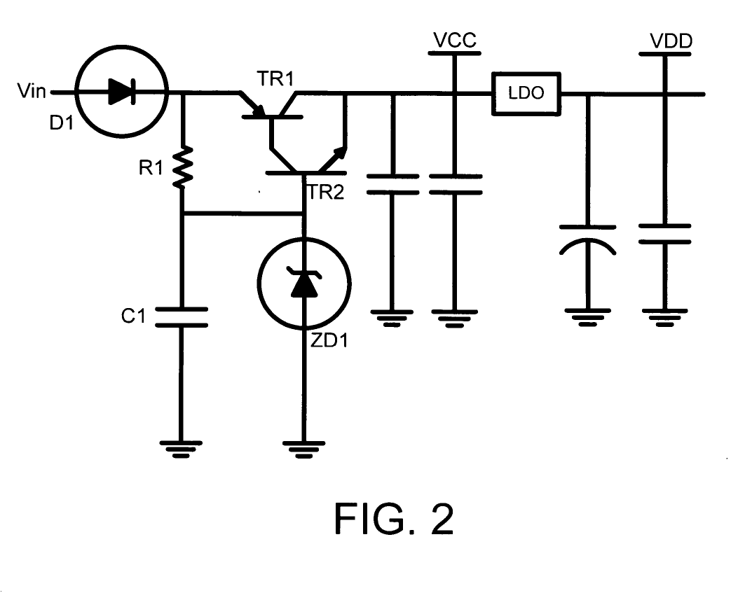

FIG. 2 shows the surge protection circuit according to the present invention incorporated into a circuit which is used in a component of a automotive vehicle. In this arrangement, a capacitor C1 is connected between ground and a junction between the resistor R1 and the base of transistor TR2. This smoothes the rise and fall in voltage which appears on the base of the transistor TR2 and modifies the timing with which the Zener diode ZD1 is rendered conductive/non-conductive. Other than this, the operation of the arrangement depicted in FIG. 2 is basically similar to that of the arrangement shown in FIG. 1.

Inasmuch as the circuitry which is shown in FIG. 2 and located to the right of the complementary Darlington pair is not directly related to the invention, a detailed description of the structure and arrangement thereof will be omitted for the sake of brevity.

Even though the invention has been described with reference to a limited number of embodiments, the various changes and modifications which can be made without departing from the scope of the invention, which is limited only the appended claims, will be immediately self evident to a person of skill in the art to which the present invention pertains, given the preceding disclosure.

1. A circuit comprising:
a surge suppressing circuit comprising first and second transistors which are arranged as a complementary Darlington pair.

2. A circuit as set forth in claim 1, further comprising:
a resistor connected between the emitter of the first transistor and the base of the second transistor; and
a Zener diode connected between the base of the second transistor and ground.

3. A circuit as set forth in claim 1, wherein the first transistor is a PNP type transistor and wherein the second transistor is a NPN type transistor.

4. A circuit as set forth in claim 1, wherein the collector of the second transistor is connected to the base of the first transistor.

5. A circuit as set forth in claim 2, further comprising a diode which is electrically connected with the emitter of the first transistor.

6. A circuit as set forth in claim 2, wherein the resistor is connected to a junction between the diode and the emitter of the first transistor.

7. A circuit as set forth in claim 2, further comprising a capacitor connected between ground and the base of the second transistor and in parallel with the Zener diode.

8. A method of surge suppression comprising interposing a surge suppressing complementary Darlington pair between an input and output.

9. A method as set forth in claim 8, wherein the complementary Darlington pair is configured by:
using a PNP transistor as the first transistor;
using a NPN transistor as the second transistor; and
connecting the base of the first transistor to the collector of the second transistor

10. A method as set forth in claim 9, further comprising:
arranging a resistor between the input and a base of the second transistor; and
connecting the base of the second transistor to ground via a Zener diode.
